(19) United States
(12) Patent Application Publication
(10) Pub. No.: US 2019/0297119 A1
(43) Pub. Date: Sep. 26, 2019

(54) ESTABLISHING DIRECT SECURE CONNECTION BETWEEN COLLABORATION DEVICES IN A ROOM OR SPACE

(71) Applicant: Cisco Technology, Inc., San Jose, CA (US)

(72) Inventors: Vikas Vashisht, Morrisville, NC (US); Pandit Panburana, Cary, NC (US)

(21) Appl. No.: 15/933,999

(22) Filed: Mar. 23, 2018

(51) Int. Cl. H04L 29/06

(52) U.S. Cl. CPC H04L 65/1069; H04W 4/80

(57) ABSTRACT

A method includes a collaboration server receiving a direct connection request from each of at least first and second devices of a plurality of devices participating in collaboration session, the direct connection requests being for initiating direct communication between the first and second devices. Each of the direct connection requests includes a location identifier indicating a location of the respective device. The method further includes determining, based on the location identifiers, if the first and second devices of the plurality of devices are at a same physical location. In response to determining that the first and second devices are at the same physical location, direct connection instructions are generated that enable the first and second devices to establish a direct connection with each other at the physical location.

### TECHNICAL FIELD

The present disclosure relates to establishing direct secure connections between collaboration devices in a room or space.

### BACKGROUND

A cloud meeting service allows multiple users through their devices to participate in an online collaboration meeting. The users may be present in different physical locations. Through the cloud meeting service, the users may exchange audio, video, and/or data in the online collaboration meeting. Thus, a user may upload audio, video, and/or data to the cloud meeting service, which then forwards the audio, video, and/or data to other participants in the collaboration meeting. In some instances, a certain level of delay may occur using the cloud meeting service and cause inconvenience to the users. For example, cloud communications for partial transcripts over a cloud interface can add a delay of 500 or more milliseconds as compared to a direct data connection between the devices in the same room. Therefore, although the user devices in the same room can communicate with each other via the cloud meeting service, there is a benefit for the users to have their devices directly connected to each other.

### BRIEF DESCRIPTION OF THE DRAWINGS

FIGS. 1A and 1B depict a collaboration system configured to enable user devices to establish direct connections, according to an example embodiment.

FIG. 2 is a block diagram of a user device configured to participate in a collaboration session and to establish a direct connection with another user device in a collaboration session, according to an example embodiment.

FIG. 3 is a block diagram of a collaboration endpoint device in a collaboration session and configured to facilitate the direct connection between user devices, according to an example embodiment.

FIG. 4 depicts a block diagram of a collaboration server configured to manage collaboration sessions according to an example embodiment.

FIG. 5 is a sequence diagram illustrating a method for managing a collaboration session and to enable direct connections between user devices, according to an example embodiment.

FIG. 6 a flow chart of a method performed by a collaboration server for managing a collaboration session and enabling direct connections between user devices, according to an example embodiment.

FIG. 7 is a flow chart of a method performed by a collaboration server to enable user devices to establish direct connections with each other in a collaboration session, according to an example embodiment.

FIG. 8 is a flow chart of a method performed by a user device for establishing direct connections with one or more other user devices participating in a collaboration session, according to an example embodiment.

### DESCRIPTION OF EXAMPLE EMBODIMENTS

### Overview

In one embodiment, a method is provided for devices participating in a collaboration session through a cloud-based collaboration server to locally and directly connect with each other. The method includes the collaboration server receiving a direct connection request from each of at least first and second devices of a plurality of devices participating in a collaboration session. The direct connection requests are for initiating direct communication between the first and second devices. Each of the direct connection requests includes a location identifier indicating a location of the respective device. The method further includes determining, based on the location identifiers, if the first and second devices of the plurality of devices are at a same physical location. In response to determining that the first and second devices are at the same physical location, the collaboration server generates direct connection instructions enabling the first and second devices to establish a direct connection with each other at the physical location. The collaboration server sends the direct connection instructions to the first and second devices so as to enable direct communication between the first and second devices.

### Example Embodiments

Presented herein are techniques to allow devices that participate in a collaboration session and are located at the same physical location to locally connect to each other so as to share data with each other using direct wired or wireless connections established between the devices.

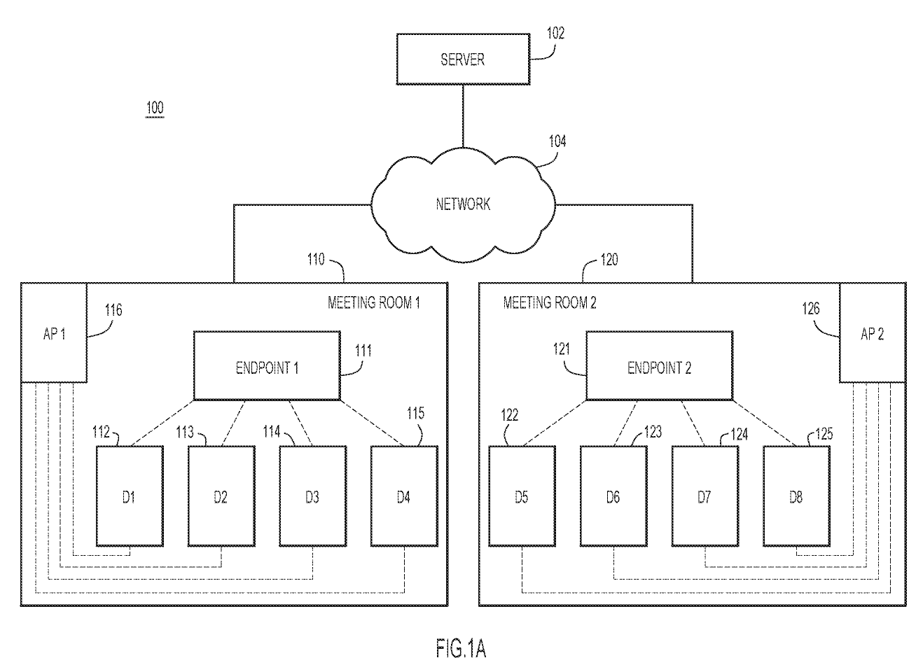

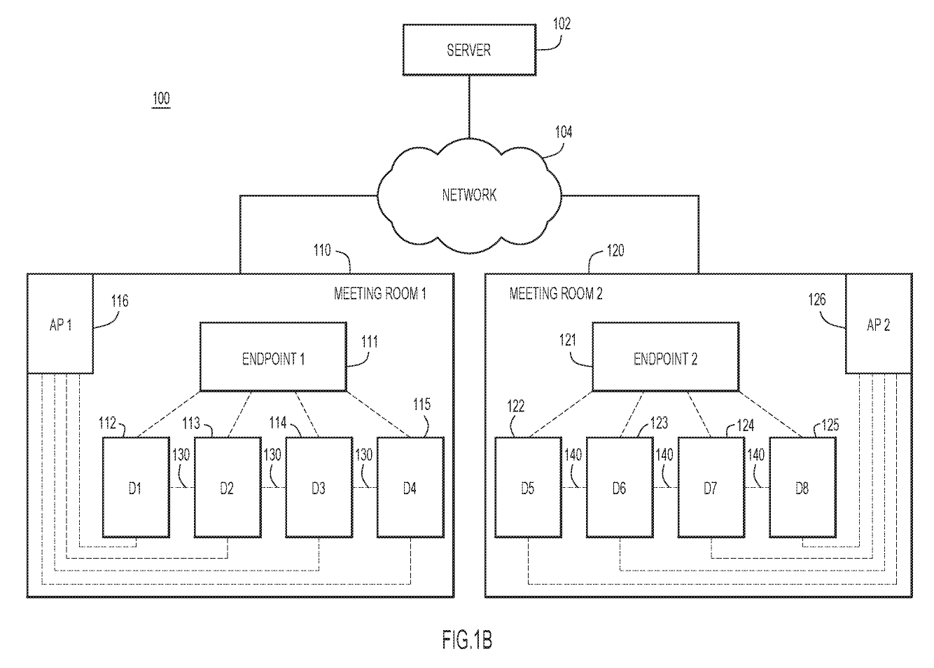

Reference is now made to FIGS. 1A and 1B for a more detailed description of the above-described system and related methods. FIG. 1A depicts a collaboration system 100 according to an example embodiment. The system 100 includes a collaboration server 102 configured to facilitate an online collaboration session through a network 104 for a plurality of user devices and endpoint devices. In the illustrated example, there are user devices participating in the collaboration session from two meeting rooms 110 and 120. For example, an endpoint device 111, four user devices D1-D4 at reference numerals 112-115, respectively, and a wireless access point AP1 at reference numeral 116 reside in meeting room 1 (110). The AP1 enables wireless local area network (WLAN) connectivity (such as Wi-Fi® wireless network connectivity) with the user devices D1-D4 in meeting room 1, and in so doing, user devices D1-D4 have network connectivity with the collaboration server 102. Similarly, an endpoint device 121, four user devices D5-D6 at reference numerals 122-125, respectively, and an access point AP2 at reference numeral 126 reside in meeting room 2 (120). AP2 enables WLAN connectivity with the user devices D5-D8 in meeting room 2, and in so doing, user devices D5-D8 have network connectivity with the collaboration server 102. The numbers of these devices shown in FIGS. 1A and 1B are merely exemplary and are not meant to limit the scope of this disclosure. Any suitable number of endpoint devices, user devices, and access points may be used. Moreover, there may be more than two meeting rooms involved in any given collaboration session.

User devices D1-D8 are joined to and participating in a collaboration session managed by the collaboration server 102. For example, as described above, user devices D1-D4 in meeting room 1 may be connected to the collaboration server 102 through the AP1 and the network 104. User devices D5-D8 in meeting room 2 may be connected to the collaboration server 102 through the AP2 and the network 104.

Each meeting room may be equipped with one or more endpoint devices that are joined to and participate in the collaboration session. Each of the endpoint devices 111 and 121 is connected to the collaboration server 102 and exchanges audio, video, and/or other data with each other through the collaboration server 102. For example, each of the endpoint devices 111 and 121 may include one or more display screens to allow the users to share data for all the users in the meeting room and to display images of participants joining from other location(s), one or more microphones to capture users' audio to be transmitted to a different location where other participants are joined the collaboration session, one or more loudspeakers that can play audio to the users in the room, and one or more cameras that can capture video in the room, including video of the users in a meeting room, to be transmitted to a different location via the collaboration server 102.

Each of the user devices D1-D8 may be wirelessly connected to or wired to a respective endpoint device 111/121 to receive audio, video, and/or data at the endpoint device. A user device can receive audio, video, and/or data from the endpoint device for presentation to an associated user. For example, when a document is showing on the display of the endpoint device, the image of the document can be transmitted from the endpoint device to a user device and displayed to its user on a screen of the user device. Conversely, a user may share content from his/her user device via the endpoint in the room for presentation to other users in the room via the endpoint or to remote users in another meeting room via the collaboration server 102. To connect the user devices D1-D8 to their respective endpoint device 111 or 121, each of the endpoint device may include a short-range communication interface, such as ultrasonic transmitter that can broadcast the endpoint's information, e.g., an Internet Protocol (IP) address, to user devices in the room. A user device in the same room as the endpoint device can listen to (receive) ultrasonic signals from the endpoint device and use the IP address of the endpoint device to establish a short-range wireless connection (e.g., a Bluetooth® wireless connection) with the endpoint device. In some embodiments, once a user device establishes a connection with the endpoint device, the user device may also be connected to the collaboration server 102 through the endpoint device.

In some embodiments, each of the endpoints 111 and 121 may instead establish local direct connections with the user devices using the methods described herein for the user devices to establish direct connections among themselves.

In FIG. 1A, the dotted lines indicate a wireless connection between the respective devices. For example, in meeting room 110, the user devices D1-D4 may establish a WLAN connection with AP1, and may also establish a wireless connection with the endpoint 111. The same applies to the dotted lines shown in meeting room 120. In some embodiments, the AP1 may have wired network capabilities (in addition to or instead of wireless connectivity) in which case the user devices D1-D4 may establish wired connections with AP1, and may also establish a wired connection with the endpoint 111 to eventually connect to the collaboration server 102. The same holds true for AP2.

In some embodiments, user devices D1-D8 log into the server 102 through the network 104 for participating in a collaboration session. User devices may log into a collaboration session based on one or more user accounts registered with the server 102 to use the collaboration services provided by the server 102. Each of the endpoints 111 and 121 also logs into the server 102 to join the collaboration session. As described above, each of the user devices D1-D8 may establish a local connection with an endpoint (111 or 121) in their respective meeting room. Once the collaboration session is set up for the user devices D1-D8 and the endpoints 111 and 121, information can be shared among these devices through the server 102. During the log-in/registration process, each of the user devices D1-D8 and endpoints 111 and 121 may provide to the server 102 various information, such as information about its display, touch-screen interface capabilities, camera(s), speaker(s), services it can support, IP address, communication protocol(s) it supports, and a secret or secrets including one or more of a password, a public key, cryptographic material(s), or a Bluetooth (BT) pin challenge or other out-of-band (OOB) authentication data. The server 102 may save the information it receives from the user devices and endpoints.

After the collaboration session starts, users associated with two or more user devices may wish to establish a local direct connection with each other in the same meeting room. For example, users associated with two or more of the user devices D1-D4 in meeting room 1 may wish to establish direct connection with each other so that they can share data directly without having to send that data through the server 102. A direct connection may reduce transmission lag caused by communications in the network or due to an overburdened state of the server 102. To initiate establishment of a direct connection between user devices, a user device may send a direct connection request to the server 102. Each of the direct connection requests includes a location identifier indicating a location of a respective user device. For example, a location identifier may be a room identifier, e.g., a room number/name, a street address, or a media access control address of an access point through which a user device communicates in order to connect to the server 102.

After receiving direct connection requests from the user devices participating in a collaboration session, the server 102 determines, based on the location identifiers included in requests received from the user devices, if any two user devices are at a same physical location. For example, the direct connection requests from user devices D1-D4 may include a first location identifier indicating they are in the same meeting room 110, while the direct connection requests from user devices D5-D8 may include a second location identifier indicating they are in the same meeting room 120. By examining the location identifiers, the server 102 is able to determine which user devices are located at the same physical location. The server 102 then proceeds to generate responses that include direct connection instructions enabling user devices at the same location to establish a direct connection with each other. For example, the server 102 may determine communications protocol capabilities of the user devices at the same location based on user device information the server 102 receives when the user devices log into the server 102. The server 102 may then determine a common communication protocol between the user devices D1-D4 (or D5-D8) and includes information about the common communication protocol in the direct connection instructions in order to enable two or more of user devices D1-D4 (or D5-D8) to establish a direct connection with each other using the common communication protocol. Any communication protocol, wireless or wired, now known or hereinafter developed may be employed by the user devices to establish direct connections with each other. Examples include Bluetooth® wireless technology, infrared communication, ultrasound communication, near-field communication, WiFi® Direct, Ethernet, etc.

In some embodiments, some of the user devices D1-D4 may support two or more communication protocols. For example, user device D1 may employ a first communication protocol to establish a direct connection with user device D2 and a second communication protocol to establish a direct connection with user device D3. As long as at least two user devices support a common communication protocol, they can employ that common communication protocol to establish a direct connection with each other.

In one embodiment, in response to the direct connection requests, the server 102 may include in its responses to the user devices D1-D8 other information to assist user devices to establish secure direct connections. For example, the direct connection instructions may include a secret for the user devices to authenticate each other without requiring user input at the user devices. Alternative or additionally, the direct connection responses may include an encryption key for the user devices to encrypt their communications to each other.

In one embodiment, the direct connection responses may include instructions that designate one of the user devices D1-D4 (or D5-D8) as a master node at the physical location. The designated master node may advertise a unique service set identifier (SSID) or Bluetooth® device identifier for the physical location.

Reference will now be made to FIG. 1B. After the user devices D1-D4 in meeting room 110 receive direct connection instructions from the server 102, the user devices D1-D4 may establish a direct connection with each other as shown as dotted lines 130 between the user devices D1 and D2, D2 and D3, and D3 and D4. Although there is no dotted line between D1 and D3, between D1 and D4, between D2 and D4, it is to be understood that each of the user devices D1-D4 can directly connect to the other user devices. Similarly, in meeting room 120, each of the user devices D5-D8 can directly connected to the other user devices as shown by the dotted lines 140. However, it is to be understood that it not necessary that all user devices in given meeting room directly connect with each other; it may be that only two user devices in a given meeting room establish a direct connection with each other at any given point in time.

In some embodiments, when a first user device sends a direct connection request to the server 102 for establishing a direct connection with a second user device at the same location, the first user device may display a user interface asking the user to enter a location identifier, such as a room number, room name, an address, etc. The location identifier is then forwarded with the direct connection request to the server 102. In one embodiment, location identifiers may be provisioned to user devices. For example, a user may enter a location identifier for one or more user devices so that the user devices can include the location identifier when sending direct connection requests to the server 102. In one embodiment, a user may register a user account with the server 102 and activate (log in) a plurality of user devices to participate in a collaboration session using the same user account. When the server 102 receives a plurality of log-in requests from different user devices using the same user account, the server 102 may determine that these devices may be at the same location. The server 102 proceeds to generate a location identifier for the user account and includes the location identifier in its log-in responses to the user devices. When the user devices send their direct connection requests to the server 102, the user devices can include in the requests the location identifier they received from the server 102.

In one embodiment, an access point (e.g., 116 or 126) or an endpoint device (e.g., 111 or 121) in a particular location may include its address as a location identifier when the access point or the endpoint device relays direct connection requests received from user devices to the server 102.

In one embodiment, when user devices are connected to an endpoint device to participate in a collaboration session, the endpoint device may send its location identifier (e.g., its IP address, unique name, the room number/name it is located, etc.) to those user devices. The user devices may then include the location identifier of the endpoint device in their direct connection requests to the server 102.

Other methods for generating and provisioning location identifiers to user devices may be employed. This disclosure is not limited to the specific examples given herein.

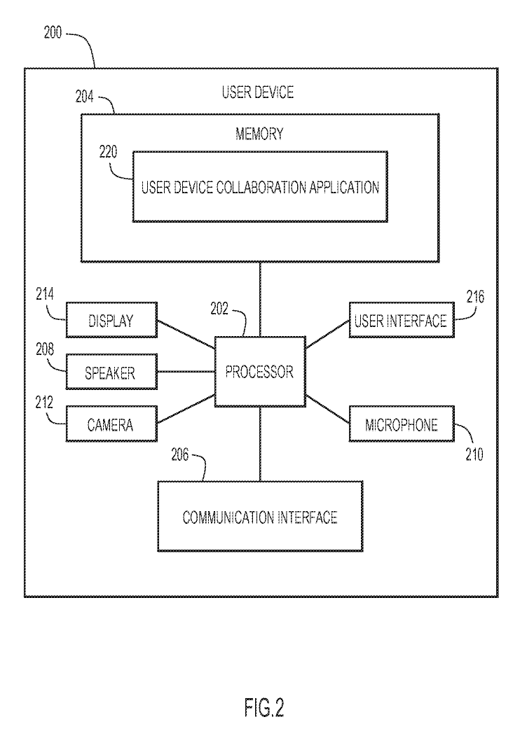

Reference is now made to FIG. 2. FIG. 2 depicts a block diagram of a user device 200 that can be employed to participate in a collaboration session, according to an example embodiment. The user device 200 may be any one of the user devices D1-D8 as shown in FIGS. 1A and 1B. The user device 200 includes a processor 202, a memory 204, and a communication interface 206. The user device 200 may also include one or more speakers 208, microphones 210, cameras 212, displays 214, and/or a user interface 216, or other components that are useful for a user in participating in a collaboration session.

The processor 202 may be a microprocessor or microcontroller (or multiple instances of such components) that is configured to execute program logic instructions (i.e., software) for carrying out various operations and tasks described herein. For example, the processor 202 is configured to execute instructions for the user device collaboration application 220 stored in the memory 204. The user device collaboration application 220 is configured to perform operations such as generating and sending log-in requests and direct connection requests to a collaboration server, receiving log-in responses and direct connection responses from the collaboration server, establishing a local connection with an endpoint device, and establishing a direct connection with another user device at the same location based on a direct connection response. Further descriptions of operations performed by the processor 202 when executing instructions stored in the memory 204 will be provided below.

The memory 204 may include read only memory (ROM), random access memory (RAM), magnetic disk storage media devices, optical storage media devices, flash memory devices, electrical, optical or other physical/tangible memory storage devices.

The functions of the processor 202 may be implemented by logic encoded in one or more tangible (non-transitory) computer-readable storage media (e.g., embedded logic such as an application specific integrated circuit, digital signal processor instructions, software that is executed by a processor, etc.), wherein the memory 204 stores data used for the operations described herein and stores software or processor executable instructions that are executed to carry out the operations described herein.

The user device collaboration application 220 may take any of a variety of forms, so as to be encoded in one or more tangible/non-transitory computer readable memory media or storage device for execution, such as fixed logic or programmable logic (e.g., software/computer instructions executed by a processor), and the processor 202 may be an application specific integrated circuit (ASIC) that comprises fixed digital logic, or a combination thereof.

For example, the processor 202 may be embodied by digital logic gates in a fixed or programmable digital logic integrated circuit, which digital logic gates are configured to execute the user device collaboration application 220. In general, the user device collaboration application 220 may be embodied in one or more computer-readable storage media encoded with software comprising computer executable instructions and when the software is executed operable to perform the operations described herein.

The communication interface 206 is configured to transmit signals to or receive signals from the network 104 or an endpoint device or one or more of other user devices in the same location, for the user device 200. For those purposes, the communication interface 206 may include a wireless transceiver, an ultrasonic transceiver, an infrared transceiver, etc., for various communications with an access point, an endpoint device, and other user devices. For example, the communication interface 206 may receive an ultrasonic signal from an endpoint device and transmits a Bluetooth® signal in response thereto. Further, the communication interface 206 may transmit log-in information or direct connection requests to the server 102 and receives log-in confirmation or direct connection instructions from the server 102 for establish direct connections with local user devices. To this end, there may be multiple types of communication interfaces supported by the user device to enable the different types of connections described herein.

The speaker 208 is coupled to processor 202 and configured to emit audio. The microphone 210 is coupled to processor 202 and configured to detect audio. The camera 212 is coupled to processor 202 and configured to capture images or video during a collaboration session. The display 214 is coupled to processor 202 and configured to display video/images or data, such as presentation materials used in a collaboration session or images of participants from other locations. The display 214 may be a flat screen or a touch screen that allows users to draw or write on it during a collaboration session. The user interface 216 is coupled to the processor 202 and configured to allow a user to control the user device 200. It is to be understood that there may be one or more additional processing ASICs connected between the speaker, camera, microphone and/or display and the processor 202 to facilitate the respective functions of those components and interaction with the processor 202. Those processing ASICs are omitted in FIG. 2 for simplicity.

The user device 200 may take the form of a SmartPhone, tablet computer, laptop computer, or other suitable mobile computing/user device now known or hereinafter developed, having computing and wireless network connectivity capabilities, or a stationary computing device in a meeting room.

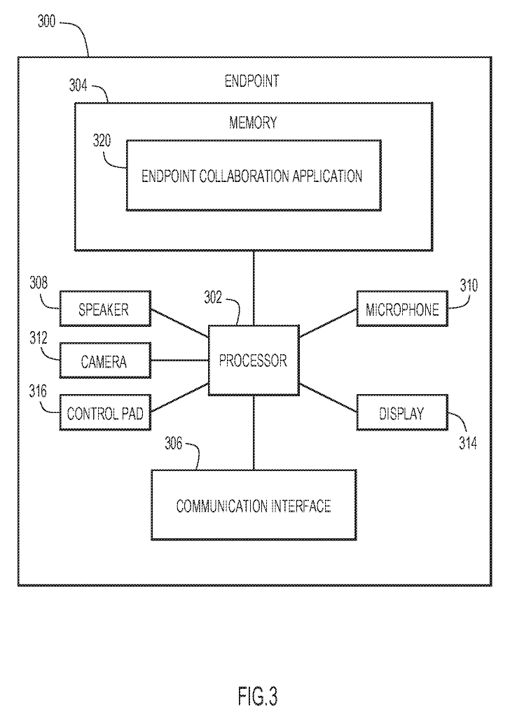

FIG. 3 depicts a block diagram of an example video conference endpoint 300 according to an embodiment. The endpoint 300 can be any one of the endpoints 111 and 121 depicted in FIGS. 1A and 1B. As shown in FIG. 3, the endpoint 300 includes a processor 302, a memory 304, a communication interface 306, one or more speakers 308, one or more microphones 310, one or more cameras 312, one or more displays 314, and a control pad 316. The processor 302 is a microprocessor or microcontroller that is configured to execute program logic instructions (i.e., software) for carrying out various operations and tasks described in this disclosure. For example, the processor 302 is configured to execute instructions for endpoint collaboration application 320 stored in the memory 304 to conduct a collaboration session with user devices. Further description of the operations performed by the processor 302 executing instructions stored in the memory 304 will be provided below.

The memory 304 may include ROM, RAM, magnetic disk storage media devices, optical storage media devices, flash memory devices, electrical, optical or other physical/tangible memory storage devices.

The functions of the processor 302 may be implemented by logic encoded in one or more tangible (non-transitory) computer-readable storage media (e.g., embedded logic such as an application specific integrated circuit, digital signal processor instructions, software that is executed by a processor, etc.), wherein the memory 304 stores data used for the operations described herein and stores software or processor executable instructions that are executed to carry out the operations described herein.

The endpoint collaboration application 320 may take any of a variety of forms, so as to be encoded in one or more tangible/non-transitory computer readable memory media or storage device for execution, such as fixed logic or programmable logic (e.g., software/computer instructions executed by a processor), and the processor 302 may be an ASIC that comprises fixed digital logic, or a combination thereof.

For example, the processor 302 may be embodied by digital logic gates in a fixed or programmable digital logic integrated circuit, which digital logic gates are configured to perform the endpoint collaboration application 320. In general, these logics may be embodied in one or more computer-readable storage media encoded with software comprising computer executable instructions and when the software is executed operable to perform the operations described herein.

The communication interface 306 is configured to transmit signals to or receive signals from the network 104 for the endpoint device 300. Likewise, communication interface 306 is configured to transmit signals to or receive signals from one or more user devices. The communication interface 306 may include a wireless transceiver, an ultrasonic transceiver, an infrared transceiver, etc., for various communications with the user devices or other devices in a meeting room. For example, the communication interface 306 may send out ultrasonic signals to discover user devices in a room and receive signals from the user devices for local connection. In addition, the communication interface 306 may transmit signals to and receive signal from the server 102. The communication interface 306 may also communicate audio, video, and/or data with the user devices for a collaboration session. Thus, it is to be understood that the endpoint 300 may have multiple communication interfaces to enable the different types of connections described herein.

The functions of the speaker 308, microphone 310, camera 312, and display 314 are similar to those of the speaker 208, microphone 210, camera 212, and display 214, and will not be described again herein. The control pad 316 of the endpoint device 300 is coupled to the processor 302 and configured to allow a user to control the endpoint. For example, the control pad may enable a user to enter instructions or to turn on or off certain functions of the endpoint 300 to facilitate a collaboration session. It is also to be understood that there may be one or more additional processing ASICs connected between the speaker, camera, microphone, display, and/or control pad, and the processor 302 to facilitate the respective functions of those components and interaction with the processor 302. Those processing ASICs are omitted in FIG. 3 for simplicity.

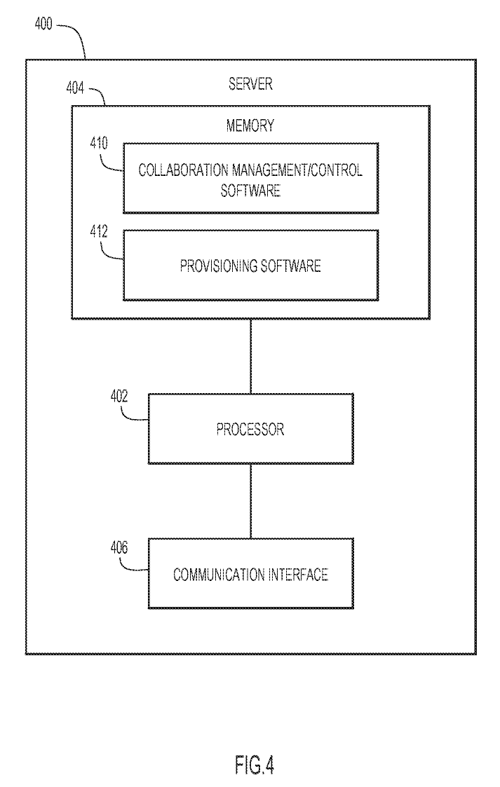

FIG. 4 depicts a block diagram of a server 400 for managing a collaboration session, according to an example embodiment. The server 400 may perform the functions of the collaboration server 102 shown in FIGS. 1A and 1B. The server 400 includes a processor 402, a memory 404, and a communication interface 406. The processor 402 may be a microprocessor or microcontroller (or multiple instances of such components) that is configured to execute program logic instructions (i.e., software) for carrying out various operations and tasks described herein. For example, the processor 402 is configured to execute instructions stored in the memory 404 for collaboration management/control software 410 to manage a collaboration session and provisioning software 412 to provision user devices and endpoint devices. Further descriptions of the operations performed by the processor 402 when executing instructions stored in the memory 404 are provided below.

The memory 404 may include ROM, RAM, magnetic disk storage media devices, optical storage media devices, flash memory devices, electrical, optical or other physical/tangible memory storage devices.

The functions of the processor 402 may be implemented by logic encoded in one or more tangible (non-transitory) computer-readable storage media (e.g., embedded logic such as an application specific integrated circuit, digital signal processor instructions, software that is executed by a processor, etc.), wherein the memory 404 stores data used for the operations described herein and stores software or processor executable instructions that are executed to carry out the operations described herein.

The collaboration management/control software 410 and the provisioning software 412 may take any of a variety of forms, so as to be encoded in one or more tangible/non-transitory computer readable memory media or storage device for execution, such as fixed logic or programmable logic (e.g., software/computer instructions executed by a processor), and the processor 402 may be an ASIC that comprises fixed digital logic, or a combination thereof.

For example, the processor 402 may be embodied by digital logic gates in a fixed or programmable digital logic integrated circuit, which digital logic gates are configured to perform the collaboration management/control software 410 and the provisioning software 412. In general, the collaboration management/control software 410 and the provisioning software 412 may be embodied in one or more computer-readable storage media encoded with software comprising computer executable instructions and when the software is executed operable to perform the operations described herein.

The communication interface 406 is configured to transmit signals to or receive signals from the network 104 for the server 400. In one example, the communication interface 406 may take the form of one or more network interface cards. For example, the communication interface 406 may receive log-in information or direct connection requests from user devices or endpoint devices and transmit log-in confirmation, denial information or direct connection instructions to the user devices and/or endpoint devices.

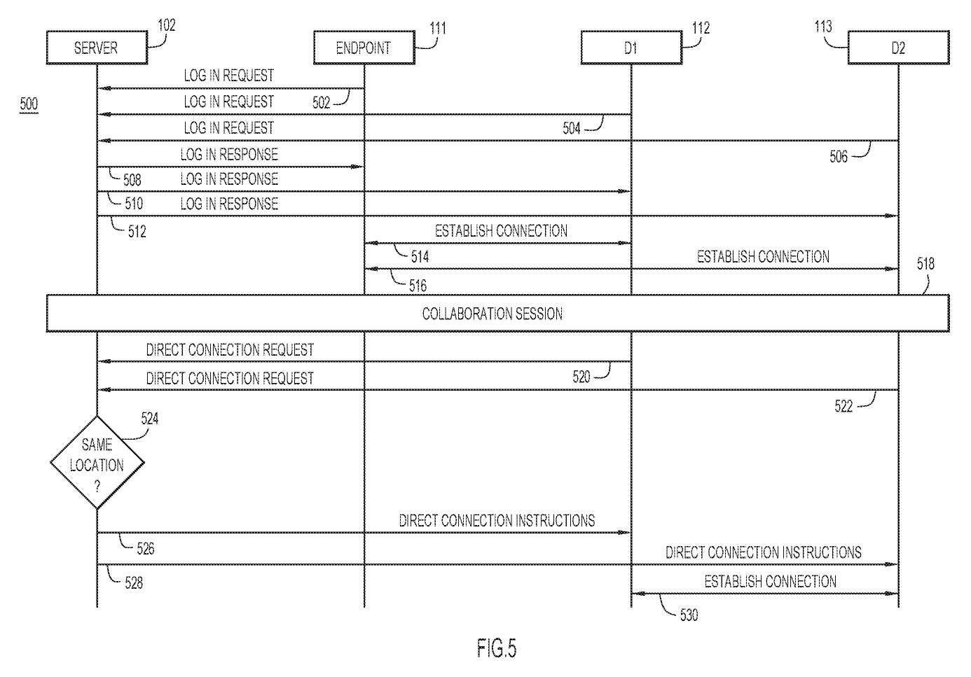

Techniques presented herein allow two or more user devices that are participating in a collaboration session through a remote server to establish a direct connection with each other so that the user devices may exchange audio, video, and/or data, and share applications locally without routing that information through the remote server. With reference to FIG. 5 and continuing reference to FIGS. 1A, 1B, and 2-4, an example method for managing a collaboration session according to one embodiment is described. FIG. 5 is a sequence diagram illustrating a method 500 for managing a collaboration session, according to an example embodiment. Although only the server 102, the endpoint device 111, user device 112 and user device 113 are depicted in FIG. 5 for simplicity, it is to be understood that any other user devices and endpoint devices may be involved in the collaboration session. The endpoint device 111, user device 112 and user device 113 are all located in meeting room 110 as shown in FIG. 1A. However, other user devices and/or endpoint devices may be located in the same meeting room 110 or a different location. In some embodiments, a user device may also participate in the collaboration session alone and without connecting to an endpoint device.

At the outset, at 502, 504, 506 each of the endpoint device 111, user device 112, and user device 113 sends to the server 102 a respective log-in request for logging into the collaboration session managed by the server 102. A log-in request may include credentials of a user account, e.g., a user name and password. At 508, 510, 512 the server 102 sends a log-in response responding to each of the log-in request to inform whether the log-in request has been approved or denied. In some embodiments, a single user account may be used by multiple user devices to log into the collaboration session, likely indicating that the log-in requests originated from the same physical location. After receiving these log-in request, the server 102 may generate a location identifier for the user account and includes the location identifier in the log-in responses to the requesting user devices, e.g., user devices 112 and 113. The location identifier may be employed later when the user devices 112 and 113 seek to establish a direct connection with each other.

At 514 and 516, the endpoint device 111 establishes a local connection with each of the user devices 112 and 113. Note that these operations are optional and may not be performed when user devices are participating in the collaboration session without an endpoint device nearby. In one embodiment, the endpoint device may periodically broadcast its address using communications techniques, such as Bluetooth®, Wi-Fi®, Near Field Communication, ultrasound, etc. In some cases, broadcasting the address of the endpoint device using ultrasonic signals may be particularly beneficial because ultrasonic signals are unlikely to travel through walls so that only user devices within the meeting room can receive the ultrasonic signals. A user device that receives the address of the endpoint 111 may use the address to send a connection request to the endpoint 111. The endpoint 111 may then forward necessary credential information and/or a shared secret to the requesting user device to enable the user device to establish a secured, local connection with the endpoint 111.

At 518, the collaboration session is established among the endpoint 111 and the user devices 112 and 113. At this point, each of the endpoint 111 and the user devices 112 and 113 has established a secured connection with the server 102 to exchange audio, video, and data among the participants in the collaboration session. For example, a user's image may be captured by a camera of the endpoint 111 and forwarded to the server 102, which then shares the user's image with other participants inside or outside of the meeting room 110, e.g., displayed on user devices D1-D8 or the endpoint 121 located in meeting room 120. In another example, a user device, such as user device 112, may share a document with the endpoint 111, which then shares the document through the server 102 with the endpoint 121 in meeting room 120. The endpoint 121 may further share the document with user devices D5-D8 at meeting room 120 through their local connections. The users at the meeting room 120 may view the document on the screen of the endpoint 121 or on the screens of user devices D5-D8. However, although the data sharing process from user device 112 through the server 102 to the user device 113 is secured in the collaboration session, it may less desirable because some level of lag may occur. Thus, it may be beneficial to establish a direct connection between the user devices 112 and 113 even though they already communicate information through the collaboration server 102.

At 520 and 522, each of the user devices 112 and 113 sends a respective direct connection request to the collaboration server 102 for initiating direct wireless communication between the user devices 112 and 113. Each of the direct connection requests includes a location identifier indicating a location of the respective device. For example, the location identifier may be a room number, a room name, a building number, a building name, a house address, or any kind of identifier that can show a location of a user device. In some embodiments, a location identifier may be an identifier shared by two or more user devices that indicates they are located in the same place but the identifier itself may not necessarily tied to a location number, name or address.

In one embodiment, a location identifier may be provisioned from the server 102 to the user devices when the user devices are activated with the server 102 or are used to log into the collaboration session with the same user account. In one embodiment, a location identifier may be negotiated between the user devices that seek to establish direct connections with each other. For example, user devices in the same room may use a room name/number and their universal unique identifier (UUID) to generate a unique SSID or a Bluetooth device identifier as a location identifier for the room. In yet another embodiment, a user device may prompt a user to enter a location identifier when sending a direct connection request to the server 102. In one embodiment, a master node in a meeting room may dictate a location identifier for slave nodes in the same location.

In some embodiments, operations 514 and 516 may be performed before, after, or at the same time as the collaboration session is initiated.

At 524, the server 102 determines, based on the location identifiers received from the user devices 112 and 113, if the user devices 112 and 113 are at a same physical location. For example, as shown in FIG. 1A, the direct connection requests from user devices D1-D4 include a same location identifier, and therefore, the server 102 can determined that they are at the same physical location. On the other hand, the direct connection requests from user devices D1 and D5 include different location identifiers such that the server 102 can determine that they are at different physical locations. When the server 102 finds any two or more user devices are at the same physical location, it may generate direct connection instructions to enable those user devices to initiate direct connection(s) with each other. For example, based on information each user device sent to the server 102 when it is activated with the server 102 or attempts to log into the collaboration session, the server 102 can determine communications protocol capabilities of the user devices and whether there is a common communication protocol between the user devices. If there is a common communication protocol between the user devices, the server 102 may inform the user devices to employ the common communication protocol for direct connection(s). In some embodiments, as long as any two user devices have a communications protocol capability, they can use the common communication protocol for their direct connection. For example, user device D1 and D2 may use a first common communication protocol, while user device D1 and D3 may use a second common communication protocol that is different from the first common communication protocol, even though user devices D1, D2, and D3 are located in the same meeting room.

In some embodiments, the server 102 may also determine a shared secret for the user devices that are to establish direct connections with each other to enable the user device to authenticate each other and establish secured connections. A shared secret may be a public key, a password, or any other cryptographic material(s) to enable the user devices to encrypt and decrepit communications between them. In some embodiments, the public key, the password, or the cryptographic materials may be generated and provided by a user device or an endpoint to the server 102.

At 526 and 528, the server 102 sends to user devices 112 and 113 direct connection instructions that enable the user devices 112 and 113 to establish a direct connection with each other in the meeting room 110. In some embodiments, the direct connection instructions may include information designating one of the user devices 112 and 113 as a master node in the meeting room 110. For example, the user device 112 may be designated as a master node in meeting room 110 and configured to advertise a unique SSID or BT device identifier for the meeting room 110. Any user device that later enters the meeting room 110 can receive and use the unique SSID or BT device identifier to establish a direct connection with the master node, user device 112.

At 530, the user devices 112 and 113 establish a direct connection that enables direct wireless communications between them. Thereafter, the user devices 112 and 113 can share information and applications they each host. For example, when user device 112 is conducting in-situ transcription of conversations in the collaboration session, the transcript can be shared directly with user device 113 without routing that information through the server 102, which may have an associated time lag.

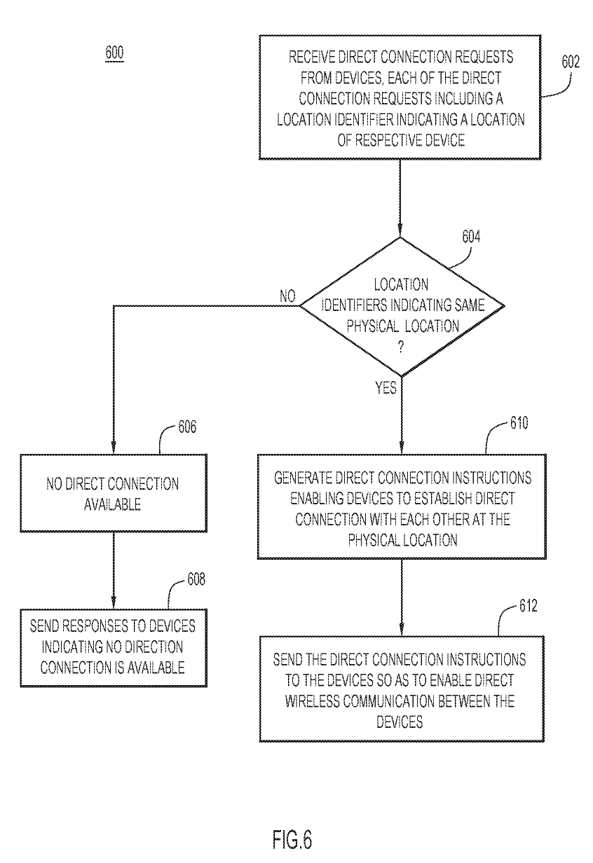

FIG. 6 is a flow chart illustrating a method 600 performed by a collaboration server for managing a collaboration session and establishing a direction connection between two or more user devices during a collaboration session, according to an example embodiment. At 602, the collaboration server receives direct connection requests from a plurality of user devices participating in a collaboration session managed by the collaboration server. Each of the direct connection requests includes a location identifier indicating a location of the respective user device. At 604, the collaboration server determines, based on the location identifiers received from the plurality of devices, whether any two or more user devices of the plurality of user devices are at the same physical location. At 606, if no two user devices are located in the same location, the server determines that no direct connection is available between the user devices. At 608 the server sends direct connection responses to the user devices indicating no direct connection is available at their respective locations. If, however, two or more user devices of the plurality of devices are at the same physical location, at 610 the server generates direct connection instructions enabling the two or more user devices to establish direct connection(s) with each other at the physical location. At 612, the server sends to the user devices direct connection responses including direct connection instructions so as to enable direct wireless communication between the user devices.

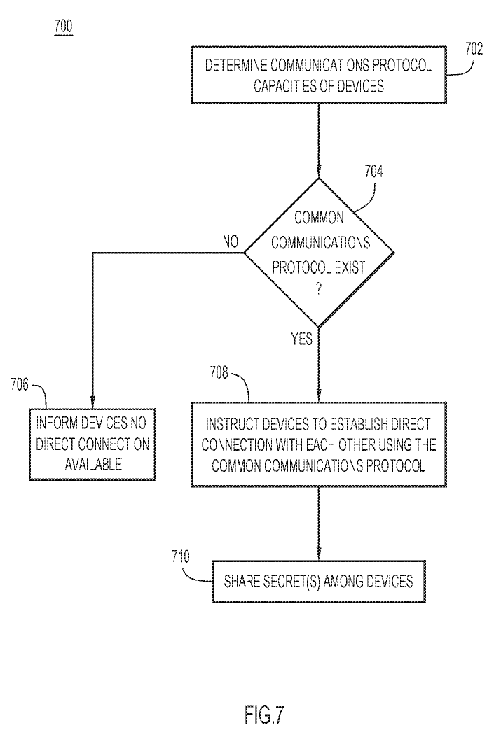

FIG. 7 is a flow chart illustrating a method 700 performed by a collaboration server to enable user devices to establish direct connection with each other in a collaboration session, according to an example embodiment. At 702, in response to receipt of direct connection requests from the user devices and a determination that the user devices are at the same location, the collaboration server determines communications protocol capabilities of the user devices. The collaboration server may consult a database that stores information about the user devices, including their communications protocol capabilities. The information about the user devices may be obtained when the user devices log in the collaboration server or when the user devices send their direct connection requests to the collaboration server. At 704, the collaboration server determines whether there is a common communication protocol between two or more of the user devices. If none of user devices at the same location employs a same communication protocol, at 706 the collaboration server informs the user devices that no direct connection is available. If there is a common communication protocol between two or more of the user devices, at 708 the collaboration server instructs those user devices to establish direct connection with each other using the common communications protocol. In some embodiments, at 710, the collaboration server further provides one or more shared secrets to the user devices such that the user devices can authenticate each other and/or encrypt their communications to establish secured connections.

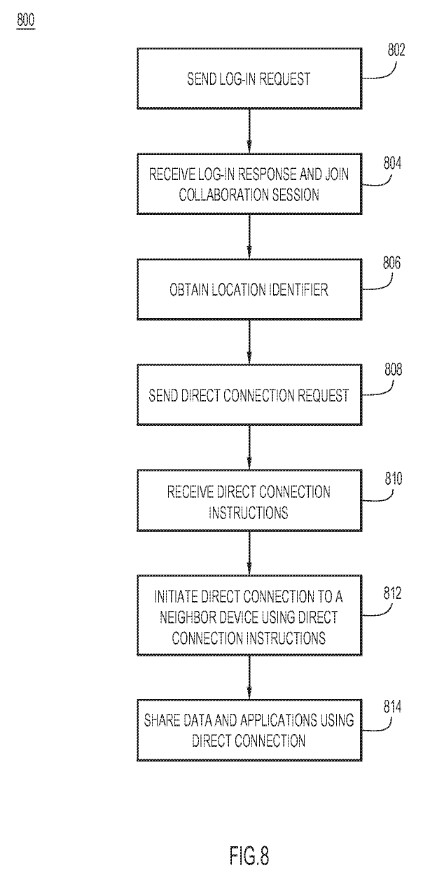

FIG. 8 is a flow chart illustrating a method 800 performed by a user device for establishing direct connections with one or more other user devices participating in a collaboration session, according to an example embodiment. At 802, the user device sends to a collaboration server a log-in request to log into the collaboration session. A user associated with the user device may enter user credentials to initiate the log-in process. At 804, the user device receives a log-in response from the collaboration server indicating the user device is allowed to participating the collaboration session. At 806, the user device obtains a location identifier indicating a location of the user device. In one embodiment, the location identifier may be provisioned from the collaboration server when the user device logs in to the collaboration server. A user of the user device may also enter a local identifier for the user device. In another embodiment, the user device may generate the location identifier based on, for example, a room number/name where it is located. At 808, the user device send to the collaboration server a direct connection request that includes the location identifier. The direct connection request is to initiate direct wireless communication with one or more other user devices in the same location. At 810, the user device receives direct connection instructions from the collaboration server. In some embodiments, the direct connection instructions may require the user device to employ a communication protocol common with that used by other user devices at the location. The direct connection instructions may further include a secret for the user device to be authenticated with other user devices without requiring any manual user input of such a secret. In some embodiments, the direct connection instructions may also include cryptographic materials, e.g., a public key or token, for the user device to encrypt communications with other user devices. At 812, the user device initiates a direct connection to another user device using direct connection instructions. Once the direct connection is successfully established, at 814 the user device may shares data and applications it hosts with other user devices participating in the collaboration through the direct connection, without routing information through the collaboration server.

It should be understood that the sequence presented in the methods explained above may be modified and is not limited to those disclosed herein.

Techniques presented herein enable user devices participating in a collaboration session through a cloud-based server to establish direct connections with each other without requiring manual user interaction. In one embodiment, the user devices that need to establish a direct connection may have a secure means to communicate via the cloud to each other and may have knowledge about device associations (static or dynamic) in some logical group(s), such as information provided at the time of provisioning (devices provisioned to same room/space/user), or may discover device association for devices that are brought in a location via a proximity solution, or other mechanisms a cloud server employed to associate devices. Internet of Things (IoT) devices that are onboarded to a same address or user account can be deemed as from the same location. A user may create one or more user accounts with a collaboration server (a trusted cloud service), and activate or configure user devices such that the user devices may securely connected to the trusted cloud service and communicate with each other through the trusted cloud service in a collaboration session.

In some embodiments, while in a collaboration session, user devices in the same location may share over the secure cloud connection: the services/applications they host, their addresses (e.g., IP addresses, Bluetooth addresses, Wi-Fi Direct SSIDs, etc.) and communication protocol capacities, and shared secrets for security purposes. The shared secret(s) may include a password, a pin challenge, a public key etc. When the collaboration server determines that some user devices are at the same physical location based on their location identifiers, the collaboration server may enable those user devices to securely connect to each other as needed. The collaboration server may share with the user devices user device information including device configurations, connection data, e.g., device IDs/names, cryptographic materials (e.g., public keys or secrets) to establish secure connections that are authenticated and encrypted.

Techniques presented herein can provide secure, direct connections between user devices that are participating in a collaboration session and are at the same location. The techniques can support multiple device groupings in the same physical space. For example, two user accounts are used by user devices in the same location to participating in a collaboration sessions. In some embodiments, the collaboration server may enable a first group of user devices that belong to one user account to establish direct connections with each other, and enables a second group of user devices that belong to another user account to establish direct connections with each other. User devices from the first group may not be permitted to establish direct connections with user devices from the second group. Further, because information for establishing direct connections are disseminated by the collaboration server through secure connections to individual user devices, the connection information can be safeguarded. Local advertisement of IP addresses, Bluetooth addresses, or Wi-Fi Direct SSIDs of the user devices can be made optional as such information is disseminated by the collaboration server so that when a user device scans its surrounding, it would not show a plurality of random device IDs normally discovered by local scanning. In one embodiment, Bluetooth addresses/SSIDs can be randomly generated, and as often as desired, to prevent denial of service (DoS).

In summary, in one aspect, a method is provided. The method includes: at a server configured to communicate with a plurality of devices participating in collaboration session, receiving a direct connection request from each of at least first and second devices of the plurality of devices, the direct connection requests being for initiating direct communication between the first and second devices, wherein each of the direct connection requests includes a location identifier indicating a location of the respective device; determining, based on the location identifiers, if the first and second devices of the plurality of devices are at a same physical location; in response to determining that the first and second devices are at the same physical location, generating direct connection instructions enabling the first and second devices to establish a direct connection with each other at the physical location; and sending the direct connection instructions to the first and second devices so as to enable direct communication between the first and second devices.

In another aspect, an apparatus is provided. The apparatus includes a network interface that enables network communications with a plurality of devices participating in collaboration session, a processor, and a memory to store data and instructions executable by the processor. The processor is configured to execute the instructions to receive a direct connection request from each of at least first and second devices of the plurality of devices, the direct connection requests being for initiating direct communication between the first and second devices, wherein each of the direct connection requests includes a location identifier indicating a location of the respective device; determine, based on the location identifiers, if the first and second devices of the plurality of devices are at a same physical location; in response to determining that the first and second devices are at the same physical location, generate direct connection instructions enabling the first and second devices to establish a direct connection with each other at the physical location; and send the direct connection instructions to the first and second devices so as to enable direct communication between the first and second devices.

In yet another aspect, a non-transitory computer-readable storage media encoded with software comprising computer executable instructions which, when executed by a processor, cause the processor to receive a direct connection request from each of at least first and second devices of the plurality of devices, the direct connection requests being for initiating direct communication between the first and second devices, wherein each of the direct connection requests includes a location identifier indicating a location of the respective device; determine, based on the location identifiers, if the first and second devices of the plurality of devices are at a same physical location; in response to determining that the first and second devices are at the same physical location, generate direct connection instructions enabling the first and second devices to establish a direct connection with each other at the physical location; and send the direct connection instructions to the first and second devices so as to enable direct communication between the first and second devices.

The above description is intended by way of example only. Various modifications and structural changes may be made therein without departing from the scope of the concepts described herein and within the scope and range of equivalents of the claims.

What is claimed is:

1. A method comprising:
at a server configured to communicate with a plurality of devices participating in collaboration session, receiving a direct connection request from each of at least first and second devices of the plurality of devices, the direct connection requests for initiating direct communication between the first and second devices, wherein each of the direct connection requests includes a location identifier indicating a location of the respective device;
determining, based on the location identifiers, if the first and second devices of the plurality of devices are at a same physical location;
in response to determining that the first and second devices are at the same physical location, generating direct connection instructions enabling the first and second devices to establish a direct connection with each other at the physical location; and
sending the direct connection instructions to the first and second devices so as to enable direct communication between the first and second devices.

2. The method of claim 1, further comprising:
determining communication protocol capabilities of the plurality of devices; and
determining a common communication protocol between the first and second devices,
wherein the direct connection instructions enable the first and second devices to establish a direct connection with each other using the common communication protocol.

3. The method of claim 1, wherein the direct connection instructions include a secret for the first and second devices to authenticate each other without requiring user input at the first and second devices.

4. The method of claim 1, wherein the location identifiers includes one of a room number, a street address, or a media access control address of an access point through which the plurality of devices communicate in order to connect to the server.

5. The method of claim 1, further comprising:
receiving log-in requests to participate in the collaboration session from the first and second devices using a same user account;
in response thereto, generating a first location identifier for the user account; and
sending log-in responses to the first and second devices, wherein each of the log-in responses includes the first location identifier.

6. The method of claim 1, wherein the direct connection instructions further include:
information designating one of the first and second devices as a master node at the physical location.

7. The method of claim 6, wherein the direct connection instructions further instruct the master node to advertise a unique service set identifier or Bluetooth® device identifier for the physical location.

8. The method of claim 1, wherein the collaboration session is supported by the server to enable audio, video, or data communications among a plurality of participants, and wherein the first and second devices are located within a meeting room that includes a video conference endpoint that has audio, video, and display capabilities for use in the collaboration session, and wherein the server is in communication with the video conference endpoint in the meeting room.

9. An apparatus comprising:
a network interface that enables network communications with a plurality of devices participating in collaboration session;
a processor; and
a memory to store data and instructions executable by the processor,
wherein the processor is configured to execute the instructions to:
receive a direct connection request from each of at least first and second devices of the plurality of devices, the direct connection requests for initiating direct communication between the first and second devices, wherein each of the direct connection requests includes a location identifier indicating a location of the respective device;
determine, based on the location identifiers, if the first and second devices of the plurality of devices are at a same physical location;
in response to determining that the first and second devices are at the same physical location, generate direct connection instructions enabling the first and second devices to establish a direct connection with each other at the physical location; and
send the direct connection instructions to the first and second devices so as to enable direct communication between the first and second devices.

10. The apparatus of claim 9, wherein the processor is further configured to:
determine communications protocol capabilities of the plurality of devices; and
determine a common communication protocol between the first and second devices,
wherein the direct connection instructions enable the first and second devices to establish a direct connection with each other using the common communication protocol.

11. The apparatus of claim 9, wherein the direct connection instructions include a secret for the first and second devices to authenticate each other without requiring input at the first and second devices.

12. The apparatus of claim 9, wherein the location identifiers includes one of a room number, a street address, or a media access control address of an access point through which the plurality of devices communicate in order to connect to the server.

13. The apparatus of claim 9, wherein the processor is further configured to:
receive log-in requests to participate in the collaboration session from the first and second devices using a same user account;
in response thereto, generate a first location identifier for the user account; and
send log-in responses to the first and second devices, wherein each of the log-in responses includes the first location identifier.

14. The apparatus of claim 9, wherein the direct connection instructions further include:
information designating one of the first and second devices as a master node at the physical location.

15. The apparatus of claim 14, wherein the direct connection instructions further instruct the master node to advertise a unique service set identifier or Bluetooth® device identifier for the physical location.

16. A non-transitory computer-readable storage media encoded with software comprising computer executable instructions which, when executed by a processor, cause the processor to:
receive a direct connection request from each of at least first and second devices of a plurality of devices participating in collaboration session, the direct connection requests for initiating direct communication between the first and second devices, wherein each of the direct connection requests includes a location identifier indicating a location of the respective device;
determine, based on the location identifiers, if the first and second devices of the plurality of devices are at a same physical location;
in response to determining that the first and second devices are at the same physical location, generate direct connection instructions enabling the first and second devices to establish a direct connection with each other at the physical location; and
send the direct connection instructions to the first and second devices so as to enable direct communication between the first and second devices.

17. The non-transitory computer-readable storage media of claim 16, wherein the instructions further cause the processor to:
determine communications protocol capabilities of the plurality of devices; and
determine a common communication protocol between the first and second devices,
wherein the direct connection instructions enable the first and second devices to establish a direct connection with each other using the common communication protocol.

18. The non-transitory computer-readable storage media of claim 16, wherein the instructions further cause the processor to:
receive log-in requests to participate in the collaboration session from the first and second devices using a same user account;
in response thereto, generate a first location identifier for the user account; and
send log-in responses to the first and second devices, wherein each of the log-in responses includes the first location identifier.

19. The non-transitory computer-readable storage media of claim 16, wherein the direct connection instructions further include:
information designating one of the first and second devices as a master node at the physical location.

20. The non-transitory computer-readable storage media of claim 19, wherein the direct connection instructions further instruct the master node to advertise a unique service set identifier or Bluetooth® device identifier for the physical location.
